(19) United States
(12) Patent Application Publication
(10) Pub. No.: US 2025/0392233 A1
(43) Pub. Date: Dec. 25, 2025

(54) PV MULTILEVEL INVERTER FEATURING FAULT TOLERANCE CAPABILITY

(71) Applicant: HAMAD BIN KHALIFA UNIVERSITY, Doha (QA)

(72) Inventors: Abdelbasset Krama, Doha (QA); Abdelbaset Laib, Doha (QA); Sertac Bayhan, Doha (QA)

(21) Appl. No.: 19/242,189

(22) Filed: Jun. 18, 2025

Related U.S. Application Data
(60) Provisional application No. 63/663,292, filed on Jun. 24, 2024.

(51) Int. Cl. H02M 7/483; H02J 3/38; H02M 1/32; H02S 40/32

(52) U.S. Cl. CPC H02M 7/4833; H02J 3/381; H02M 1/325; H02S 40/32; H02J 2300/26

(57) ABSTRACT

Example systems, methods, and apparatuses are disclosed herein for a PV multilevel inverter featuring fault tolerance capability. The system, methods, and apparatuses include a single phase multilevel inverter topology having fault-tolerant capability, allowing continued operation with a reduced number of voltage levels in the event of open-circuit faults in power switches or damage to DC capacitors, without requiring any modification to the core power circuit. In some embodiments, the inverter topology is capable of generating up to thirteen voltage levels under normal operating conditions and comprises six power switches, three four-quadrant switches, and four DC capacitors supplied by a single DC source. In some embodiments, control of the inverter topology is achieved through a reconfigurable model predictive control (R-MPC) scheme that seamlessly manages transitions among different circuit configurations, including Packed E-Cell (PEC) and Packed U-Cell (PUC) topologies.

### PRIORITY CLAIM AND CROSS-REFERENCE TO RELATED APPLICATIONS

The present application claims priority to and the benefit of U.S. Provisional Patent Application No. 63/663,292 filed Jun. 24, 2024, which is incorporated herein by reference in its entirety and relied upon.

### BACKGROUND

Photovoltaic (PV) arrays rely on inverters to convert direct current (DC) voltage generated by the PV array to alternating current (AC) voltage, which is used in the electrical grid. In addition to converting a DC input into an AC output, inverters may include components which may be used to produce a voltage that varies over time (e.g., in the form of a repeating sine wave), which can be input into the power grid. The shape (e.g., frequency and voltage amplitude) of the sine wave output by the inverter is critical, because electrical equipment is designed and built to operate on only certain frequencies and voltages. Unlike turbine-based electrical power generators, inverter-based generators do not have the same inertia to resist changes in frequency. As such, there is a need for new and improved inverters that can stabilize the electric grid against faulty inverter output.

### SUMMARY

Example systems, methods, and apparatus are disclosed herein for a photovoltaic (PV) multilevel inverter comprising fault tolerance capability. This capability enables continued operation with a reduced number of voltage levels in the event of open-circuit faults in power switches or damage to DC capacitors, without requiring any modification to the core power circuit. The inverter disclosed herein is configured to generate up to thirteen voltage levels under normal operating conditions. The example systems, methods, and apparatus disclosed herein comprises six power switches, three four-quadrant switches, and four DC capacitors. The systems, methods, and apparatus disclosed herein is supplied by a single DC source. Control is achieved through a reconfigurable model predictive control (R-MPC) scheme that seamlessly manages transitions among different circuit configurations, including Packed E-Cell (PEC) and Packed U-Cell (PUC) topologies. The R-MPC also enables precise regulation of capacitor voltage levels, significantly improving system adaptability, fault resilience, and overall performance across diverse application scenarios.

In light of the disclosure herein, and without limiting the scope of the invention in any way, in a first aspect of the present disclosure, which may be combined with any other aspect listed herein unless specified otherwise, a PV multilevel inverter including fault tolerance capability is disclosed. The PV multilevel inverter comprises a plurality of switches including a plurality of power switches and a plurality of bidirectional switches, a plurality of DC capacitors, each one of the plurality of DC capacitors connected between at least one of the plurality of power switches and at least one of the plurality of bidirectional switches, and a controller configured to regulate a power output of the PV multilevel inverter according to grid input frequency and grid input voltage. The controller regulates the power output by varying an inverter configuration by setting a switching state for each of the switches in order to set the inverter configuration to one of a first plurality of inverter configurations of a first switching mode, each one of the first plurality of inverter configurations corresponding to one of a first plurality of voltage levels. Further, in response to failure of one or more of the plurality of switches and/or one or more of the plurality of DC capacitors, the converter selects a first alternative switching mode and setting the switching state for each of the switches in order to set the inverter configuration to one of a second plurality of inverter configurations of the first alternative switching mode, each one of the second plurality of inverter configurations corresponding to one of a second plurality of voltage levels.

In a second aspect of the present disclosure, which may be combined with any other aspect listed herein unless specified otherwise, a number of the second plurality of inverter configurations is the same as or less than a number of the first plurality of inverter configurations.

In a third aspect of the present disclosure, which may be combined with any other aspect listed herein unless specified otherwise, the number of the first plurality of inverter configurations is one of thirteen, nine, or seven and wherein the number of the second plurality of inverter configurations is one of thirteen, nine, or seven.

In a fourth aspect of the present disclosure, which may be combined with any other aspect listed herein unless specified otherwise, each one of the first plurality of inverter configurations and each one of the second plurality of inverter configurations is one of a packed e-cell (PEC) or a packed u-cell (PUC) configuration.

In a fifth aspect of the present disclosure, which may be combined with any other aspect listed herein unless specified otherwise, the controller is further configured to regulate the power output by, in response to a failure of another one or more of the plurality of switches or the plurality of DC capacitors, setting the switching state for each of the switches in order to set the inverter configuration to one of a third plurality of inverter configurations of a second alternative switching mode, each one of the third plurality of inverter configurations corresponding to one of a third plurality of voltage levels.

In a sixth aspect of the present disclosure, which may be combined with any other aspect listed herein unless specified otherwise, the first alternative switching mode is one of six alternative switching modes.

In a seventh aspect of the present disclosure, which may be combined with any other aspect listed herein unless specified otherwise, the plurality of power switches includes six power switches.

In an eight aspect of the present disclosure, which may be combined with any other aspect listed herein unless specified otherwise, the plurality of bidirectional switches includes three four-quadrant switches.

In a nineth aspect of the present disclosure, which may be combined with any other aspect listed herein unless specified otherwise, the plurality of DC capacitors includes four DC capacitors.

In a tenth aspect of the present disclosure, which may be combined with any other aspect listed herein unless specified otherwise, a PV system including fault tolerance capability is disclosed. The PV system comprises a PV array, a boost converter configured to draw power from the PV array, a fault detection system configured to determine a fault status of the PV system, a PV multilevel inverter configured to convert DC voltage from the boost converter into an AC voltage. The PV multilevel inverter comprises a plurality of switches including a plurality of power switches and a plurality of bidirectional switches, a plurality of DC capacitors, each one of the plurality of DC capacitors connected between at least one of the plurality of power switches and at least one of the plurality of bidirectional switches, and a controller configured to regulate a power output of the PV multilevel inverter according to grid input frequency and grid input voltage by varying an inverter configuration by based on the fault status of the PV system, selecting a first alternative switching mode of six alternative switching modes, and setting a switching state for each of the switches in order to set the inverter configuration to one of a first plurality of inverter configurations of the first alternative switching mode, each one of the first plurality of inverter configurations corresponding to one of a first plurality of voltage levels.

In an eleventh aspect of the present disclosure, which may be combined with any other aspect listed herein unless specified otherwise, the fault status corresponds to a failure in one or more of the plurality of switches and/or one or more of the plurality of DC capacitors.

In a twelfth aspect of the present disclosure, which may be combined with any other aspect listed herein unless specified otherwise, the fault detection system determines the fault status using current and/or voltage sensors.

In a thirteenth aspect of the present disclosure, which may be combined with any other aspect listed herein unless specified otherwise, the boost converter is configured to optimize the power draw from the PV array using maximum power point tracking (MPPT).

In a fourteenth aspect of the present disclosure, which may be combined with any other aspect listed herein unless specified otherwise, the PV system is configured to supply the power output of the PV multilevel inverter to a power grid.

In a fifteenth aspect of the present disclosure, which may be combined with any other aspect listed herein unless specified otherwise, a method of using a PV multilevel inverter including fault tolerance capability is disclosed. The method comprises boosting a voltage of power received by a PV array to generate a stepped up DC voltage, supplying the stepped up DC voltage to a PV inverter, detecting a fault status of the PV inverter, the fault status corresponding to a failure in one or more of a plurality of switches of the PV inverter and/or one or more of a plurality of DC capacitors of the PV inverter, converting the DC voltage to an AC voltage by the PV inverter by selecting a switching mode to one of six alternative switching modes based on the fault status, and varying an inverter configuration between ones of a plurality of inverter configurations of the switching mode, each one of the plurality of inverter configurations corresponding to a voltage level, and supplying the AC voltage to a power grid.

In a sixteenth aspect of the present disclosure, which may be combined with any other aspect listed herein unless specified otherwise, the method further includes detecting an updated fault status of the PV inverter based on failure of another one or more of the plurality of switches of the PV inverter and/or the plurality of DC capacitors of the PV invertor; and selecting a second switching mode from the six alternative switching modes based on the updated fault status.

In a seventeenth aspect of the present disclosure, which may be combined with any other aspect listed herein unless specified otherwise, each one of the six alternative switching modes includes thirteen, nine, or seven inverter configurations.

In an eighteenth aspect of the present disclosure, which may be combined with any other aspect listed herein unless specified otherwise, the detecting of the fault status includes sensing one or more of current and voltage of the PV inverter.

In a nineteenth aspect of the present disclosure, which may be combined with any other aspect listed herein unless specified otherwise, the method further includes regulating the AC voltage to correspond to a grid frequency and a grid voltage by the varying of the inverter configuration.

In a twentieth aspect of the present disclosure, which may be combined with any other aspect listed herein unless specified otherwise, the boosting of the voltage includes using MPPT to optimize a power draw from the PV array.

In a twenty-first aspect of the present disclosure, any of the structure, functionality, and alternatives disclosed in connection with any one or more of FIGS. 1 to 8 may be combined with any other structure, functionality, and alternatives disclosed in connection with any other one or more of FIGS. 1 to 8.

In light of the present disclosure and the above aspects, it is therefore an advantage of the present disclosure to allow continuous power input to a power grid by including fault tolerance capability in a PV multilevel inverter.

It is another advantage of the present disclosure to dynamically reconfigure the inverter between different configurations using reconfigurable model predictive control.

It is an additional advantage of the present disclosure to allow for continued operation (e.g., supply of an AC voltage at grid-compatible voltages and frequencies) of the PV inverter in the event of failure of one or more of its components, without requiring modification to the core power circuit.

It is a further advantage of the present disclosure to enhance the quality of power provided to the power grid while minimizing required passive filter for grid integration.

Additional features and advantages are described in, and will be apparent from, the following Detailed Description. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE DRAWINGS

FIG. 1 shows a system configuration of the disclosed technology, according to an example embodiment of the present disclosure.

FIG. 2 shows switching modes of the example inverter of the disclosed technology under faulty conditions, according to an example embodiment of the present disclosure.

FIG. 3 shows the control method for the system disclosed herein, according to an example embodiment of the present disclosure.

FIGS. 4A-4Z show the 26 possible configurations of the example inverter of the disclosed technology, according to an example embodiment of the present disclosure.

FIGS. 5A-5G show the power circuit of the different possible configurations of the example PV inverter of the disclosed technology, according to an example embodiment of the present disclosure.

FIGS. 6A-6B show steady state waveforms of (A) grid current; and and grid voltage (B) output voltage using the R-MPC method, according to an example embodiment of the present disclosure.

FIGS. 7A-7E show various operations of the disclosed technology using the R-MPC method in healthy conditions: (A) irradiance; (B) PV power; (C) DC link voltage; (D) capacitor voltage; and (E) grid current, according to an example embodiment of the present disclosure.

FIGS. 8A-8D show system performance when an open circuit fault affects both four-quadrant switches S8 and S9: (A) DC link voltage; (B) capacitor voltage; (C) grid current; and (D) output voltage of the disclosed technology using the R-MPC method, according to an example embodiment of the present disclosure.

FIGS. 9A-9D show the overall system performance in the event of an open circuit fault that affects four-quadrant switches S7 and S8: (a) DC link voltage; (B) capacitor voltage; (C) grid current; and (D) output voltage of the disclosed technology based on the R-MPC method, according to an example embodiment of the present disclosure.

### DETAILED DESCRIPTION

Methods, systems, and apparatus are disclosed herein for a PV multilevel inverter featuring fault tolerance capability. While the example methods, apparatus, and systems are disclosed herein for a multilevel inverter featuring fault tolerance capability to be used with PV arrays, it should be appreciated that the methods, apparatus, and systems may be operable for other applications.

Solar Photovoltaics (PV) can minimize the dependency on conventional fossil fuels, which contribute to greenhouse gas in the environment. The use of PV technology, which will never run out of its energy source (e.g., solar power), ensures the sustainability of the electricity supply offered by PV technology.

Most PV plants are connected to distribution networks, and mainly to the 11 kilovolt (kV) and 0.415 kV levels. It is expected that the penetration level of PV electricity generation will reach 15% of total generation capacity by 2030. Despite assurance that this penetration level is practical, having such a high level of total generation capacity may require various accommodations or management strategies to be put in place to avoid causing problems in distribution networks. The most highlighted issues that may require management include voltage variations, which in most cases results in a voltage limit violation. The problem arises due to the variation of solar power output and conventional control of voltage in the distribution network. The conventional voltage control scheme is designed for controlling voltage in the passive distribution network, but when generation sources are introduced in the distribution network, the effectiveness of the conventional voltage control scheme can be significantly affected.

The technology disclosed herein can produce thirteen voltage levels using a reduced number of passive and active components (e.g., a single DC source, four capacitors, six switches, three four quadrant switches) as compared to known thirteen voltage level inverters. Examples disclosed herein exhibit a dynamic resilience by seamlessly transitioning between various multilevel converter topologies including PEC and PUC configurations. A reconfigurable model predictive control (R-MPC) technique enables seamless transitions between different topologies while adjusting DC-link capacitors' voltage levels for optimal performance. The proposed technology featuring fault-tolerant capability can provide uninterrupted converter operation despite open circuit faults or damage to DC capacitors.

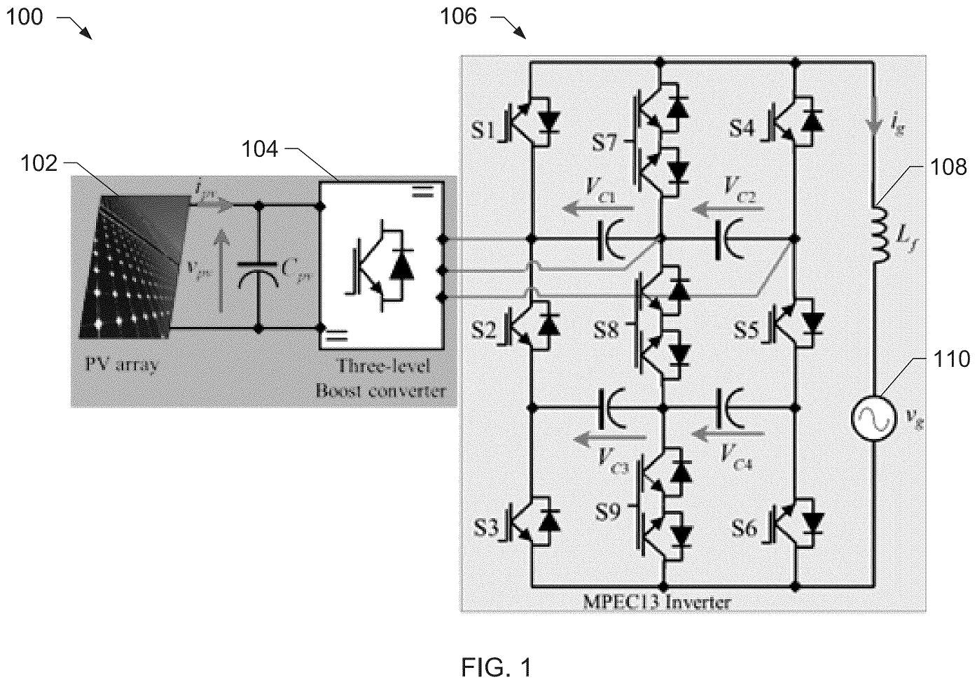

FIG. 1 illustrates the structure of the inverter-based grid-connected PV system 100 disclosed herein. The example PV system 100 consists of a PV array 102, a boost converter 104, a PV inverter 106, an L filter 108, and the grid 110.

The example PV array 102 captures sunlight and converts solar energy into a direct current (DC) voltage through PV cells. The example PV array 102 may include a plurality of connected PV modules, which may include a plurality of PV cells. The PV array 102 is connected to the grid 110 through the boost converter 104, the PV inverter 106, and the L filter 108.

The DC voltage output by the example PV array 102 has a current (iₚᵥ) and a voltage level (vₚᵥ). The example boost converter 104 receives the DC voltage from the example PV array 102 and steps up the voltage level (vₚᵥ) provided by the PV array 102 to a higher DC output voltage. In the example of FIG. 1, the boost converter 104 is a three-level DC/DC boost converter. In other embodiments, the boost converter 104 may be any other suitable type of boost converter such as a conventional boost converter, an interleaved boost converter, a push-pull converter, a half-bridge boost converter, a full-bridge boost converter or any other suitable DC/DC boost converter.

The example PV inverter 106 receives a DC voltage output from the boost converter 104 and regulates the DC voltage into an alternating current (AC) voltage that is suitable for input into the grid 110. The topology of the example PV inverter 106 of FIG. 1 includes six power switches (i.e., S1, S2, S3, S4, S5, S6), three four-quadrant switches (i.e., S7, S8, S9), and four DC capacitors (i.e., V_{C1}, V_{C2}, V_{C3}, V_{C4}).

The example power switches and the example four-quadrant switches comprise NPN bipolar junction transistors (BJT) with having a reverse (e.g., freewheeling) diode. Each example BJT comprises a p-type semiconductor situated between two n-type semiconductors and has a conductor, an emitter, and a base. When operated in an active mode, the BJT may amplify an input signal. When operated in a saturation (e.g., on) mode, current flows freely from the collector to the emitter. When operated in a cut-off (e.g., off) mode, the BJT acts like an open circuit and no current flows from the collector to the emitter. The reverse diode of the BJT is configured to protect the switch from damage by the reverse current of an inductive load. For example, when current flow is suddenly interrupted, the reverse current can flow through the diode and dissipate rather than a high voltage damaging the switch.

In some embodiments, the example four-quadrant switches comprise common emitter bidirectional switches. In a conducting (e.g., on) mode, the bidirectional switches allow current flow from a first end of the bidirectional switch to a second end of the bidirectional switch. Additionally, in the conducting mode, the bidirectional switch allows current flow from the second end of the bidirectional switch to the first end of the bidirectional switch. Accordingly, the four-quadrant switches provide for current flow in two directions. In a non-conducting (e.g., off) mode, the bidirectional switches function as an open circuit and block current flow in both directions. In some embodiments, the BJTs of the switches of the PV inverter 106 may be replaced with metal oxide semiconductor field effect transistors (MOFSETs) which may provide the switching capabilities to operate the PV inverter 106.

The example DC capacitors of the PV inverter 106 are connected between to one or more of the switches of the PV inverter 106. For example, a first terminal of each one of the DC capacitors may be connected to one or more of the power switches, an output of the boost converter 104 and a second DC capacitor and a second terminal of the DC capacitor may be connected to one or more of the power switches, one or more of the four-quadrant switches, an output of the boost converter 104 and a second DC capacitor.

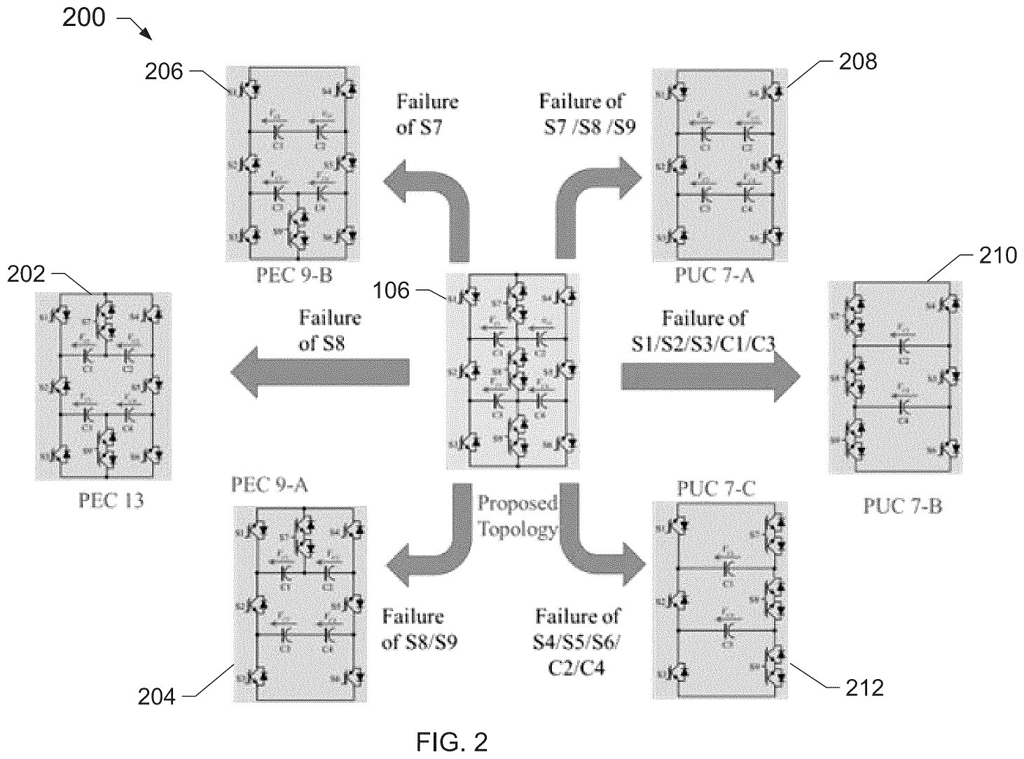

The topology of the PV inverter 106 allows for reconfiguration into six alternative switching modes, which are described below with respect to FIG. 2. This flexibility enables improved performance under various operating conditions and enhances adaptability to changing system requirements. Incorporation of three bidirectional switches (e.g., the three four-quadrant switches (i.e., S7, S8, S9)) in the PV inverter 106 improves redundancy in the PV inverter 106 compared to known inverters and allows for enhanced capacitor voltage balancing capabilities. For example, incorporation of the bidirectional switches allows for the six alternative switching modes whereas known inverters may have fewer (e.g., three, two, one, zero) alternative switching modes. The improved redundancy of the PV inverter 106 provides greater stability and reliability in operation, which is desirable for grid-tied PV systems such as the PV system 100.

The example PV system 100 of FIG. 1 further includes an L filter 108 electrically connected to the PV inverter 106. The example L filter 108 may be a passive filter consisting of an inductor which attenuates harmonics (i.e., high-frequency components) by opposing changes in current. For example, high-frequency components generated by the PV inverter 106 may be mitigated by the example L filter 108. Additionally, the example L filter 108 may improve the quality of the power output by the PV system 100 by matching the impedance of the inverter to the grid. While the example PV system 100 of FIG. 1 uses the L filter 108, other suitable low-pass filters may be used such as an LC-type filter or an LCL-type filter.

Accordingly, the example PV system 100 may transfer energy captured by the PV array 102 into the grid 110. The example grid 110 may be an electrical network that delivers electricity from one or more power sources to consumers of the electricity. The example grid 110 may operate at a grid frequency (e.g., 60 Hertz (Hz), 50 Hz) and a grid voltage (e.g., 110V, 100-127V, 220V, 240V, etc.). Accordingly, the example PV system 100 is configured to supply electricity to the grid 110 at approximately the grid frequency and the grid voltage. In some embodiments, the PV inverter 106 disclosed herein may be used to supply electricity to another type of power storage such as a rechargeable battery.

The example PV system 100 disclosed herein is configured to provide continuous PV power production, even in the event of component failure within the PV inverter 106. For example, in the event of failure of any of the switches (e.g., S1, S2, S3, S4, S5, S6, S7, S8, S9) or capacitors (e.g., V_{C1}, V_{C2}, V_{C3}, V_{C4}) the example PV system 100 can continue to provide power to the grid 110 with the desired frequency and voltage properties. In some embodiments, the PV inverter 106 can continue to operate even in the event of failure of two or more of the components (e.g., switches and/or capacitors) of the PV inverter 106. In some embodiments, the PV inverter 106 can continue to provide power to the grid 110 even in the event of failure of two or more components without the use of external devices.

Continuous power production is achieved by the example PV system 100 by a control scheme including the following components. First, a voltage-oriented maximum power point tracking (MPPT) based on current model predictive control is used by the boost converter 104. For example, based on the current that the boost converter 104 draws from the PV array 102, the voltage from the PV array 102 will vary, leading to a change in power draw (e.g., Power=Current*Voltage). A maximum power point corresponds to a particular current/voltage combination for a given PV array 102 condition which produces a maximum power output for all possible current/voltage combinations. As conditions change (e.g., amount of solar radiation), the maximum power point also changes. Thus, using MPPT, the boost converter 104 uses a trial and error process to continuously adjust the amount of current drawn from the PV array 102 and measure the resulting power output in an effort to maintain the largest power output possible. Additionally, a control algorithm provides seamless switching between different combinations of the boost converter 104 to adapt to operational changes of the PV inverter 106 during faulty conditions. Further, a simple proportional-integral (PI) is used to regulate the DC-link voltage while generating the grid current reference.

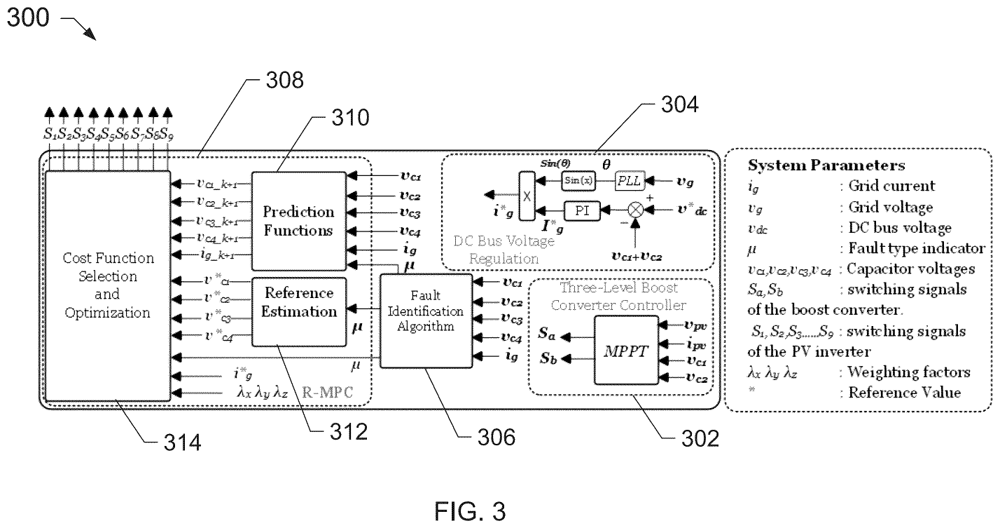

In addition, the R-MPC method disclosed herein is implemented to track the current and voltage references using a predictive model and a cost function that are dynamically readapted at each sampling interval. This adaptation is guided by a fault indicator generated by a fault identification algorithm, allowing for seamless transitions between different inverter topologies including PEC13, PEC9-A, PEC9-B, PUC7-A, PUC7-B, and PUC7-C as illustrated in FIG. 2 and FIG. 3 and described below.

FIG. 2 shows example switching modes of the disclosed inverter of the PV system 100 of FIG. 1. The topology of the example PV inverter 106 of FIG. 1 is referred to herein as a modified Packed E-Cell thirteen-level inverter (MPEC13). In the example MPEC13 of the PV inverter 106, all nine of the switches (e.g., S1, S2, S3, S4, S5, S6, S7, S8, S9) and all four of the capacitors (e.g., V_{C1}, V_{C2}, V_{C3}, V_{C4}) are functional. Accordingly, the PV inverter 106 is capable of outputting 13 voltage levels. Further, the MPEC13 topology of the PV inverter 106 has one or more switch configurations with which to produce each of the 13 desired voltage levels.

Example PEC 13 inverter topology 202 results from a fault (e.g., an open circuit fault) in four-quadrant switch S8. As with the MPEC13 topology of the PV inverter 106, all 13 desired voltage levels can be output by the example PEC 13 inverter topology 202. However, due to the failure of switch S8, only one switch configuration is available to produce each of the 13 desired voltage levels.

Example PEC 9-A inverter topology 204 results from a fault in four-quadrant switch S9. In some embodiments, example PEC 9-A inverter topology 204 results from a fault In both four-quadrant switch S8 and four-quadrant switch S9. The example PEC 9-A inverter topology 204 is capable of outputting 9 voltage levels. Similarly, example PEC 9-B inverter topology 206 results from a fault in four-quadrant switch S7. The example PEC 9-B inverter topology 206 is capable of outputting 9 voltage levels.

Example PUC 7-A inverter topology 208 may result from a failure of two or more of the three four-quadrant switches S7, S8, and S9. The example PUC 7-A inverter topology 208 is capable of outputting 7 voltage levels. Example PUC 7-B inverter topology 210 may result from a failure of any or more of switch S1, switch S2, switch S3 and capacitors V_{C1} or V_{C3}. The example PUC 7-B inverter topology 210 is capable of outputting 7 voltage levels. Example PUC 7-C inverter topology 212 may result from a failure of any one or more of switch S4, switch S5, switch S6 and capacitor V_{C2} or V_{C4}. The example PUC 7-C inverter topology 212 is capable of outputting 7 voltage levels.

FIG. 3 shows a control method 300 for the PV system 100 disclosed herein. The example control method 300 may be executed by one or more controllers which may receive and provide inputs to the components of the PV system 100. In some embodiments, the one or more controllers include microcontrollers. In other embodiments, the controllers may include microprocessors, FPGAs, ASICs or any other suitable controller technology. The example control method 300 includes a boost converter controller 302, a DC-bus voltage regulator 304, a fault-identification algorithm 306, and the reconfigurable model predictive control (R-MPC) module 308.

As described above, the example boost converter controller 302 uses MPPT control to continuously adjust the amount of current drawn from the PV array 102 in an effort to maintain the largest possible power draw. As inputs, the boost converter controller 302 considers the voltage of the PV array 102 (vₚᵥ), the current of the PV array 102 (iₚᵥ), a voltage of a first capacitor of the boost converter 104 (v_{C1}) and a voltage of a second capacitor of the boost converter 104 (v_{C2}). Based on these inputs and controller logic, the boost converter controller 302 determines switching signals for one or more switches of the boost converter 104 (Sₐ, S_{b}).

The example DC-bus voltage regulator 304 uses a proportional-integral (PI) to regulate the DC link voltage while generating the grid current reference (i_{g}*). As input, the DC-bus voltage regulator 304 considers the grid voltage (v_{g}), the reference DC bus voltage (v_{dc}*), the voltages of the capacitors of the boost converter 104 (v_{C1}, v_{C2}), and the reference DC current (I_{g}*).

The example fault-identification algorithm 306 checks the fault status of the PV inverter 106. For example, the fault-identification algorithm 306 determines if one or more faults have occurred in the PV inverter 106 and the location of the one or more faults. In order to check the fault status, the fault identification algorithm considers the voltages of the capacitors of the inverter topology (v_{C1}, v_{C2}, v_{C3}, v_{C4}), the grid current (i_{g}), and fault detection logic and determines a fault type indicator (μ). In some embodiments, the voltages and the grid current may be determined based on one or more voltage and/or current sensors. The fault type indicator (μ) may describe a fault status of the example inverter. In some embodiments, the fault status indicates one or more components of the PV inverter 106 (e.g., a switch or a capacitor) which have failed and the location of the failure (e.g., an open circuit fault in switch S8). In some embodiments, the fault status may indicate that the PV inverter 106 is functioning normally (e.g., without any failure of any of the components).

The example R-MPC module 308 includes prediction functions 310, a reference estimation module 312 and a cost function module 314. The example R-MPC module 308 provides an adaptive model predictive control algorithm, allowing the power converter to seamlessly adapt to switch and/or capacitor failures in the PV inverter 106, ensuring continuous operation with minimal performance degradation. Thus, the PV system 100 disclosed herein is configured to maintain operation even in the event of switch or capacitor failures. The example prediction functions 310 predict the voltage for each of the four capacitors of the PV inverter 106 at the next sampling interval (v_{C1_k+1}, v_{C2_k+1}, v_{C3_k+1}, v_{C4_k+1}) as well as the grid current at the next sampling interval (i_{g}_{ₖ}₊₁) based on the voltage of each of the four capacitors of the PV inverter 106 (v_{C1}, v_{C2}, v_{C3}, v_{C4}), the grid current (i_{g}), and the fault type indicator (μ) provided by the fault identification algorithm 306. The example reference estimation module 312 uses the fault type indicator (μ) provided by the fault-identification algorithm 306 to determine reference voltage values for each of the capacitors of the PV inverter 106 (v_{C1}*, v_{C2}*, v_{C3}*, v_{C4}*).

The example cost function module 314 draws on inputs from the DC-bus voltage regulator 304, the fault-identification algorithm 306, the prediction functions 310, and the reference estimation module 312. The cost function module 314 then selects an appropriate cost function equation and runs the optimization to generate switching states for each configuration of PV inverter 106. In some embodiments, the fault-identification algorithm 306 outputs a fault status indicator (μ), which is then used to select the corresponding reference estimation functions, prediction functions, and cost function equations needed to establish the appropriate switching mode for PV inverter 106 and generate the switching states. For example, if the fault status indicates that the PV inverter 106 is functioning without any fault, the cost function 314 may decide to operate the PV inverter 106 using the MPEC13 configuration of the PV inverter 106. In another example, if the fault status indicates a failure in switch S8, the appropriate cost function may decide to operate the PV inverter 106 using the PEC 13 inverter topology 202. In other embodiments, the cost function 314 may select another suitable switching mode based on the fault status.

After selection of a switching mode, the example cost function 314 may determine switching states (S1, S2, S3, S4, S5, S6) for the switches of the PV inverter 106. For example, the cost function 314 considers one or more inputs (e.g., the grid current reference (it), the fault type indicator (μ), the predicted voltage for each of the four capacitors of the PV inverter 106 at the next sampling interval (v_{C1_k+1}, v_{C2_k+1}, v_{C3_k+1}, v_{C4_k+1}), the reference voltage values for each of the capacitors of the PV inverter 106 (v_{C1}*, v_{C2}*, v_{C3}*, v_{C4}*) and optionally one or more weighting factors (λₓ, λ_{y}, λ_{z})) and selects a configuration for the PV inverter 106. The selected configuration corresponds to a voltage output of the PV inverter 106 (e.g., a voltage input (Vᵢₙ) to the AC load).

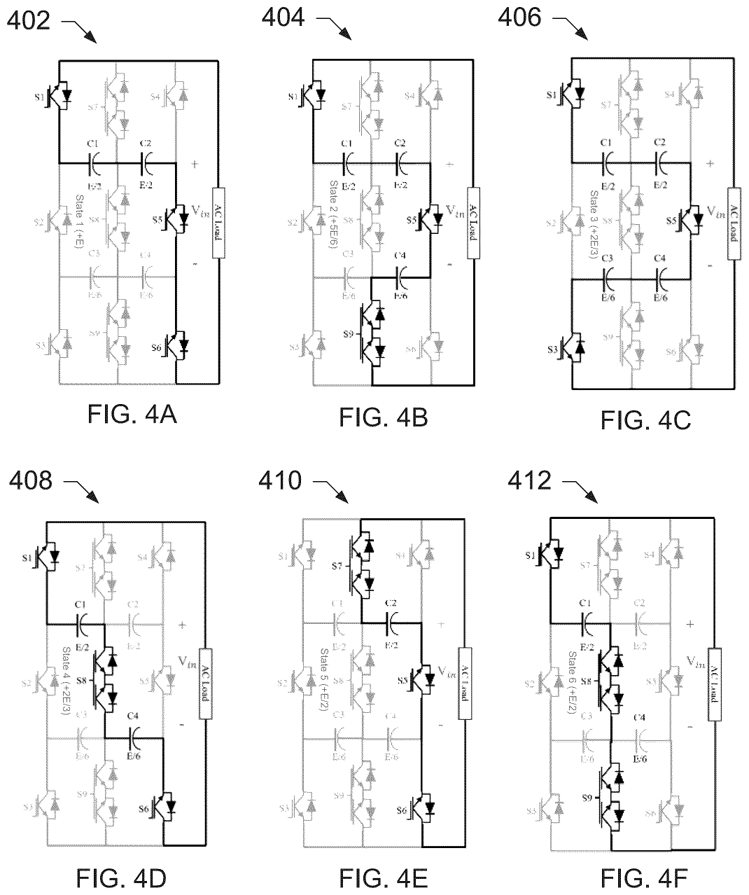

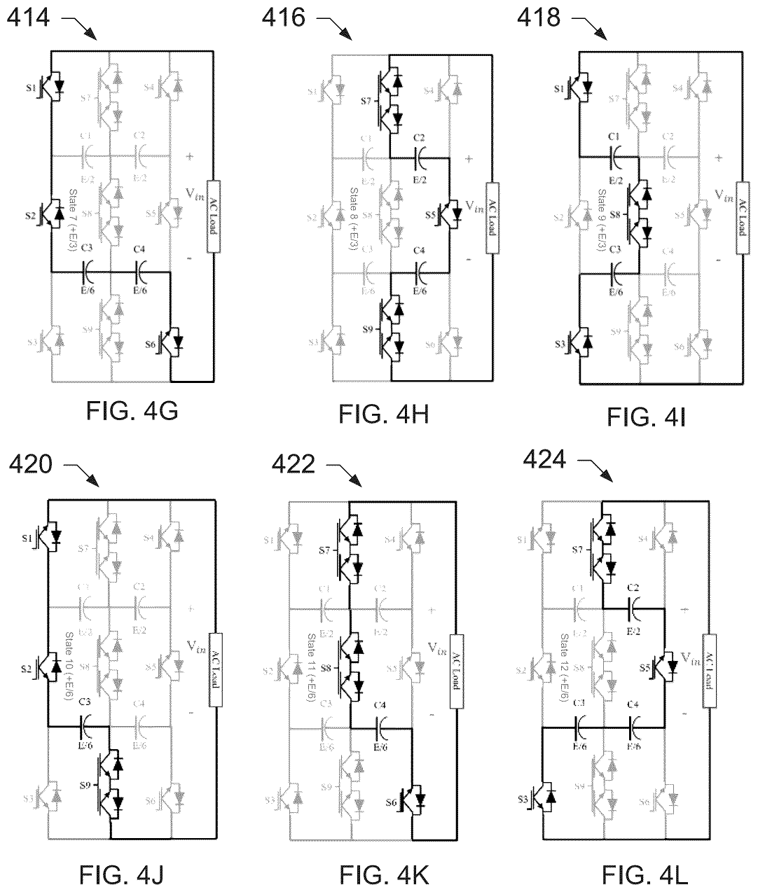

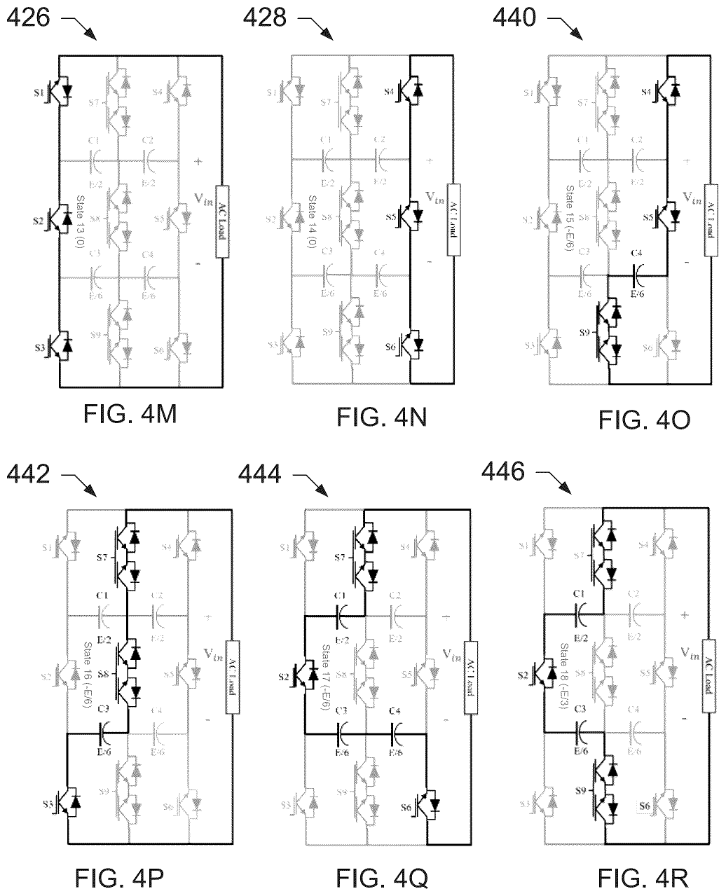

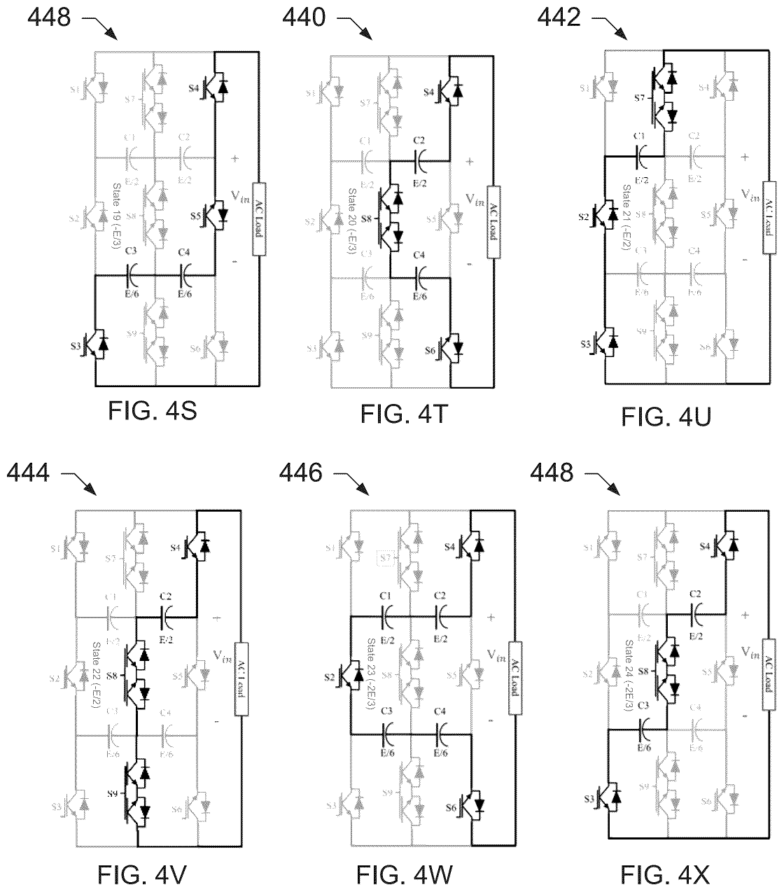

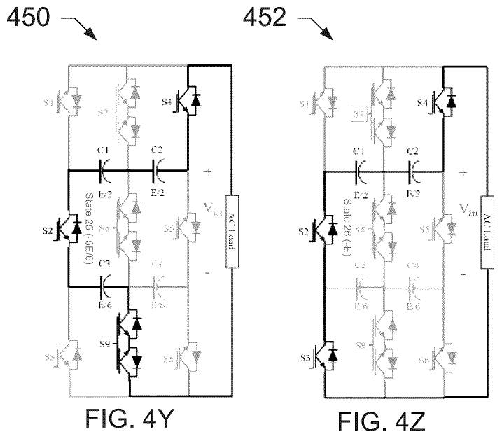

FIGS. 4A-4Z show the 26 possible configurations of the example PV inverter 106. In each of the 26 example configurations, each of the switches S1-S9 are in an on-state or an off-state. A flow path of current through the example inverter depends on the switching states of each of the switches S1-S9. In each of the 26 example configurations, current flows through from zero to four of the capacitors, V_{C1}, V_{C2}, V_{C3}, and V_{C4}. Depending on the number and configuration of the capacitors in the circuit, the voltage input (Vᵢₙ) to the AC load (e.g., the grid 110) changes. Accordingly, Vᵢₙ may be set by configuring the state of each of the nine switches.

Table I below includes the switching states for each of the 9 switches S1-S9 for each of the 26 configurations. Table I also includes the Vᵢₙ which results from each of the configurations. The configurations 1-26 of Table I correspond to the configurations illustrated in FIGS. 4A-4Z respectively.

TABLE I
Switching states of the example multilevel inverter.

| Switching | | | | | | | | | | |
|---|---|---|---|---|---|---|---|---|---|---|
| state | Vin | S1 | S2 | S3 | S4 | S5 | S6 | S7 | S8 | S9 |
| 1 | Vc1 + Vc2 = +E | 1 | 0 | 0 | 0 | 1 | 1 | 0 | 0 | 0 |
| 2 | Vc1 + Vc2 − Vc4 = +5E/6 | 1 | 0 | 0 | 0 | 1 | 0 | 0 | 0 | 1 |
| 3 | Vc1 + Vc2 − Vc3 − Vc4 = +2E/3 | 1 | 0 | 1 | 0 | 1 | 0 | 0 | 0 | 0 |
| 4 | Vc1 + Vc4 = +2E/3 | 1 | 0 | 0 | 0 | 0 | 1 | 0 | 1 | 0 |
| 5 | Vc2 = +E/2 | 0 | 0 | 0 | 0 | 1 | 1 | 1 | 0 | 0 |
| 6 | Vc1 = +E/2 | 1 | 0 | 0 | 0 | 0 | 0 | 0 | 1 | 1 |
| 7 | Vc3 + Vc4 = +E/3 | 1 | 1 | 0 | 0 | 0 | 1 | 0 | 0 | 0 |
| 8 | Vc2 − Vc4 = +E/3 | 0 | 0 | 0 | 0 | 1 | 0 | 1 | 0 | 1 |
| 9 | Vc1 − Vc3 = +E/3 | 1 | 0 | 1 | 0 | 0 | 0 | 0 | 1 | 0 |
| 10 | Vc3 = +E/6 | 1 | 1 | 0 | 0 | 0 | 0 | 0 | 0 | 1 |
| 11 | Vc4 = +E/6 | 0 | 0 | 0 | 0 | 0 | 1 | 1 | 1 | 0 |
| 12 | Vc2 − Vc3 − Vc4 = +E/6 | 0 | 0 | 1 | 0 | 1 | 0 | 1 | 0 | 0 |
| 13 | 0 | 1 | 1 | 1 | 0 | 0 | 0 | 0 | 0 | 0 |
| 14 | 0 | 0 | 0 | 0 | 1 | 1 | 1 | 0 | 0 | 0 |
| 15 | −Vc4 = −E/6 | 0 | 0 | 0 | 1 | 1 | 0 | 0 | 0 | 1 |
| 16 | −Vc3 = −E/6 | 0 | 0 | 1 | 0 | 0 | 0 | 1 | 1 | 0 |
| 17 | Vc3 + Vc4 − Vc1 = −E/6 | 0 | 1 | 0 | 0 | 0 | 1 | 1 | 0 | 0 |
| 18 | Vc3 − Vc1 = −E/3 | 0 | 1 | 0 | 0 | 0 | 0 | 1 | 0 | 1 |
| 19 | −Vc4 − Vc3 = −E/3 | 0 | 0 | 1 | 1 | 1 | 0 | 0 | 0 | 0 |
| 20 | Vc4 − Vc2 = −E/3 | 0 | 0 | 0 | 1 | 0 | 1 | 0 | 1 | 0 |
| 21 | −Vc1 = −E/2 | 0 | 1 | 1 | 0 | 0 | 0 | 1 | 0 | 0 |
| 22 | −Vc2 = −E/2 | 0 | 0 | 0 | 1 | 0 | 0 | 0 | 1 | 1 |
| 23 | Vc3 + Vc4 − Vc1 − Vc2 = −2E/3 | 0 | 1 | 0 | 1 | 0 | 1 | 0 | 0 | 0 |
| 24 | −Vc2 − Vc3 = −2E/3 | 0 | 0 | 1 | 1 | 0 | 0 | 0 | 1 | 0 |
| 25 | Vc3 − Vc1 − Vc2 = −5E/6 | 0 | 1 | 0 | 1 | 0 | 0 | 0 | 0 | 1 |
| 26 | −Vc1 − Vc2 = −E | 0 | 1 | 1 | 1 | 0 | 0 | 0 | 0 | 0 |

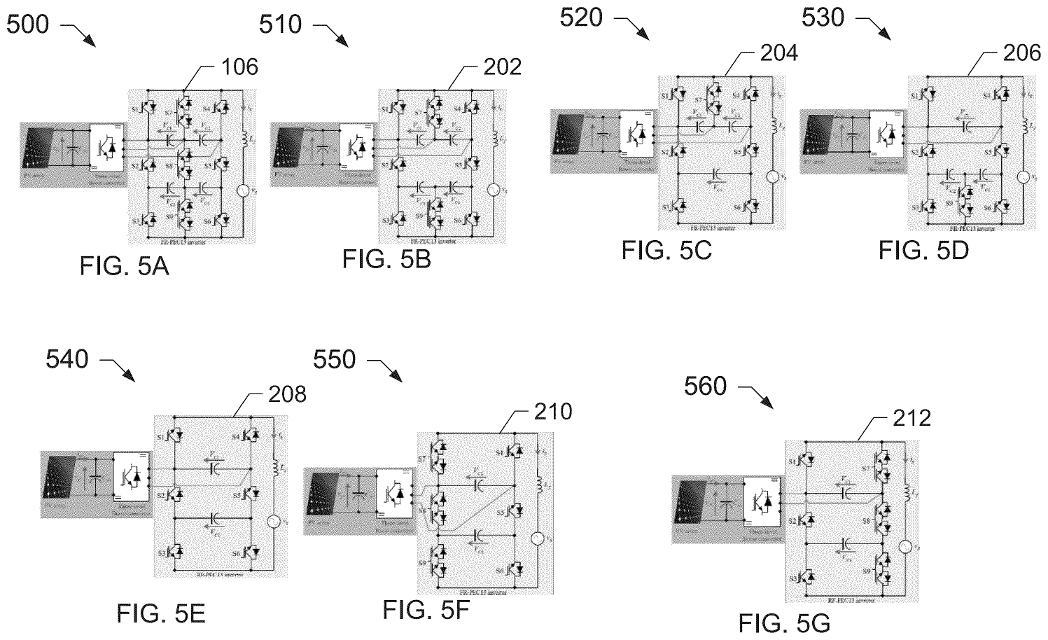

FIGS. 5A-5G show example PV systems employing the example inverter topologies illustrated in FIGS. 1 and 2. In the example PV system 500 of FIG. 5A, the MPEC13 topology of the PV inverter 106 of FIG. 1 is illustrated which can output each of the 13 voltage levels using multiple configurations for each level. In the example PV system 510 of FIG. 5B, the example PEC 13 inverter topology 202 is illustrated which can output each of the 13 voltage levels. In the example PV system 520 of FIG. 5C, the example PEC 9-A inverter topology 204 is illustrated which can output 9 voltage levels. In the example PV system 530 of FIG. 5D, the example PEC 9-B inverter topology 206 is illustrated which can output 9 voltage levels. In the example PV system 540 of FIG. 5E, the example PUC 7-A inverter topology 208 is illustrated which can output 7 voltage levels. In the example PV system 550 of FIG. 5F, the example PUC 7-B inverter topology 210 is illustrated which can output 7 voltage levels. In the example PV system 560 of FIG. 5G, the example PUC 7-C inverter topology 212 is illustrated which can output 7 voltage levels.

### EXAMPLES

### Example 1

The grid-connected PV system 100 of FIG. 1 including the reconfigurable MPC method was simulated using MATLAB/Simulink. The system parameters as detailed in Table II were used for the simulations. The performance of the example PV inverter 106 was first assessed under normal operating conditions as well as varying solar radiation levels and open power switch fault scenarios.

TABLE II
Overall system parameters.

| | Value | |
|---|---|---|
| PV Module Parameters | | |
| Maximum power (Pmpp) | 119.972 | Watts |
| Open circuit voltage (Voc) | 42.1 | V |
| Short circuit current (Isc) | 3.87 | A |
| Voltage at MPP | 33.7 | V |
| Current at MPP | 3.56 | A |
| Number of cells per module | 72 | |
| PV Array Configuration | | |
| Modules in series per string | 4 | |
| Parallel strings | 6 | |
| Inverter and Grid Parameters | | |
| Filtering inductor (L) | 1 | mH |
| DC Capacitors | 4700 | μF |
| Grid RMS Voltage (vg) | 230 | V |
| Grid frequency | 50 | Hz |
| Three-Level Boost Converter Parameters | | |
| Boost Capacitor | 2200 | μF |
| Boost Inductor | 10 | mH |
| Sampling Times | | |
| MPPT (Tp) | 1 | ms |
| R-MPC (Ts) | 20 | μs |

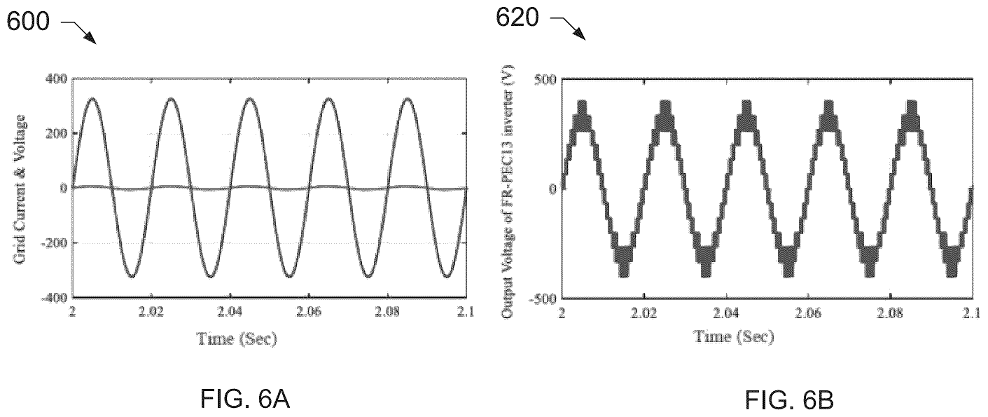

FIG. 6A shows steady state waveforms of grid current and grid voltage used for the simulation. The grid current and grid voltage shown in FIG. 6A demonstrate a unity power factor operation which is indicative of efficient power transfer. FIG. 6B shows steady state waveforms of the output voltage of the PV system 100 voltage using the R-MPC method disclosed herein. The output voltage depicted in FIG. 6B is simulated during healthy operation (e.g., without any fault in the PV inverter 106). In this embodiment, thirteen distinct voltage levels are present in the output voltage waveform.

### Example 2

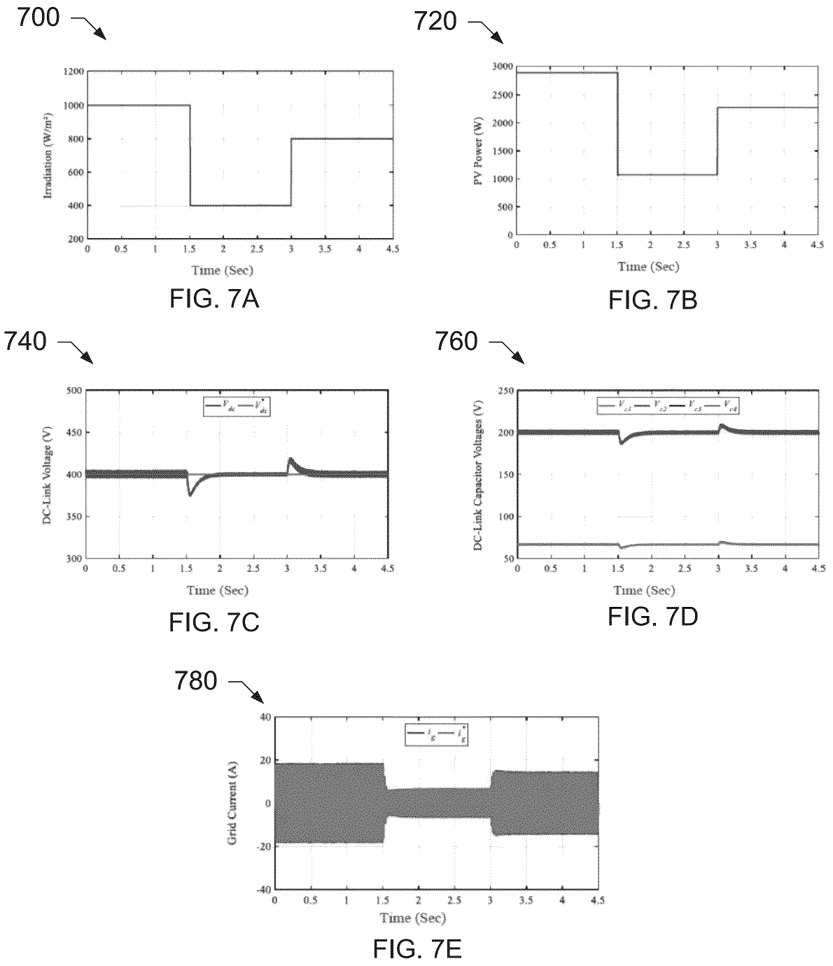

In the second example illustrated in FIGS. 7A-7E, the example PV system 100 was evaluated by simulating step changes in solar radiation to assess its basic performance. Specifically, two sudden irradiation changes were simulated as shown in FIG. 7A: an irradiance drop from 1000 m²/W to 400 m²/W at 1.5 seconds and an irradiance increase from 400 m²/W to 800 m²/W at 3 seconds. In FIG. 7B, power output of the PV system 100 is illustrated which shows that the PV system 100 rapidly teaches the new maximum power point (MPP) following the two sudden irradiation changes. In FIGS. 7C and 7D it can be seen that the DC link voltage and capacitor voltage experience undershoot and overshoot in response to the sudden irradiation changes at 1.5 seconds and 3 seconds. However, essentially perfect regulation of the capacitors of the PV inverter 106 is maintained as illustrated by the PV power curve of FIG. 7B. Furthermore, FIG. 7E illustrates that the measured grid current accurately tracks its reference value. Total harmonic distortion of the measured grid current does not exceed 3.5% under these operating conditions.

### Example 3

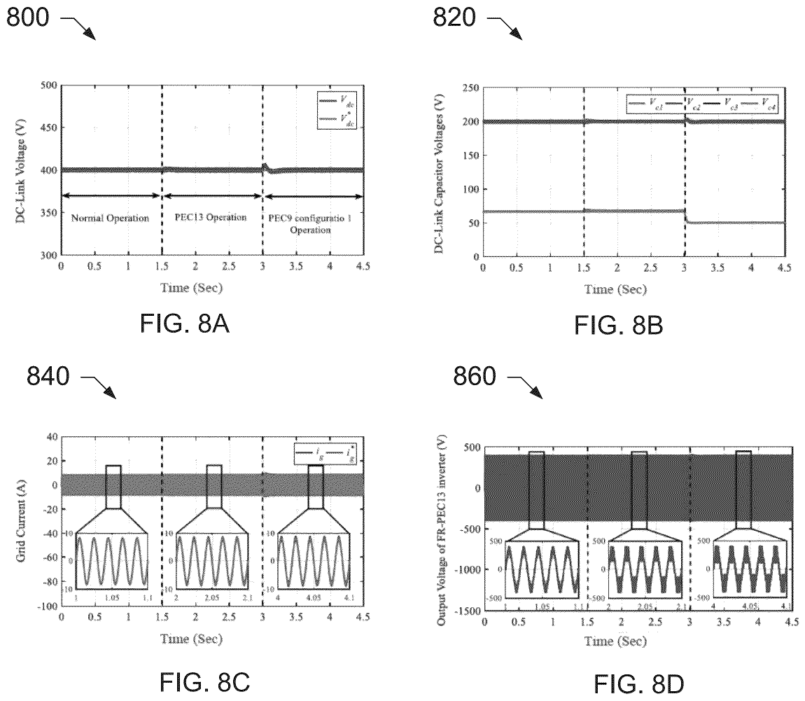

In the third example illustrated in FIGS. 8A-8D, the example PV system 100 was evaluated for two sequential fault conditions. Specifically, an open circuit fault occurs at 1.5 seconds in the four-quadrant switch S8 and another open circuit fault occurs at 3 seconds in the four-quadrant switch S9 (i.e., both S8 and S9 failed from 3 seconds). Thus, from 0 to 1.5 seconds, the PV inverter 106 operates in normal conditions. From 1.5 to 3 seconds, the inverter switches modes to the PEC13 operation of the inverter topology 202 of FIG. 2. From 3 seconds, the inverter switches modes to the PEC9-A inverter topology 204 of FIG. 2.

FIG. 8D illustrates that, from 1.5 to 3 seconds, the proposed inverter topology continues to generate a thirteen-level output voltage even when an open circuit fault occurs in the four-quadrant switch S8. Throughout this event, both the DC-link voltage (FIG. 8A) and grid current (FIG. 8C) maintain tracking of their references without experiencing any undershoot or overshoot. However, there is a slight degradation in the balancing performance of the DC capacitor voltages (FIG. 8B) compared to their performance during normal operation.

At 3 seconds, in response to the fault in four-quadrant switch S9, the switching mode of the inverter changes to the PEC9-A configuration. Despite this change, a nine-level voltage output of the inverter is ensured, as seen in FIG. 8D, by achieving proper balancing of the DC capacitor voltages, while simultaneously regulating the DC-link voltage around its reference, as presented in FIGS. 8A-8B. Furthermore, FIG. 8C illustrates that the grid current maintains its sinusoidal form while accurately tracking its reference.

### Example 4

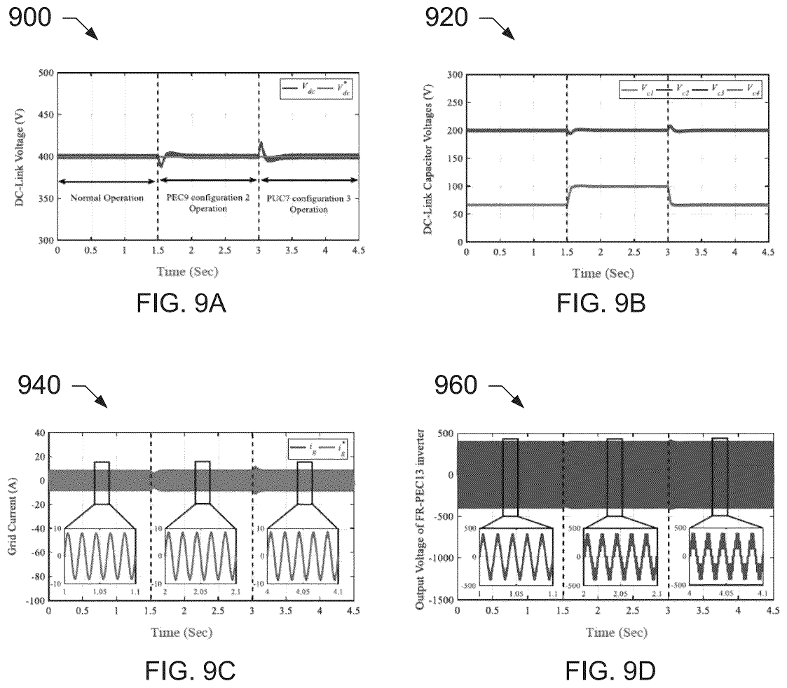

In the fourth example illustrated in FIGS. 9A-9D, the example PV system 100 was evaluated for two sequential fault conditions. Specifically, an open circuit fault occurs at 1.5 seconds in the four-quadrant switch S7 and another open circuit fault occurs at 3 seconds in the four-quadrant switch S8 (i.e., both S7 and S8 failed from 3 seconds). Thus, from 0 to 1.5 seconds, the PV inverter 106 operates in normal conditions (MPEC13 configuration). From 1.5 to 3 seconds, the inverter switches modes to the PEC9-B operation of the inverter topology 206 of FIG. 2. From 3 seconds, the inverter switches modes to the PUC7-A inverter topology 208 of FIG. 2.

These switching mode configurations are clearly seen in the output voltage illustrated in FIG. 9D. For example, FIG. 9D illustrates that, from 1.5 to 3 seconds, the proposed inverter topology generates a nine-level output voltage when an open circuit fault occurs in the four-quadrant switch S7. At 3 seconds, in response to the additional fault in four-quadrant switch S8, the switching mode of the inverter changes to the PUC7-A configuration. Despite this change, a seven-level voltage output of the inverter is ensured, as seen in FIG. 9D, by achieving proper balancing of the DC capacitor voltages, while simultaneously regulating the DC-link voltage around its reference, as presented in FIGS. 9A-9B. Despite these faults and configuration changes, the grid current continued to track its reference in a sinusoidal form, as demonstrated in FIG. 9C.

### CONCLUSION

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A photovoltaic (PV) multilevel inverter including fault tolerance capability, the PV multilevel inverter comprising:
a plurality of switches including a plurality of power switches and a plurality of bidirectional switches;
a plurality of DC capacitors, each one of the plurality of DC capacitors connected between at least one of the plurality of power switches and at least one of the plurality of bidirectional switches; and
a controller configured to regulate a power output of the PV multilevel inverter according to grid input frequency and grid input voltage by varying an inverter configuration by:
setting a switching state for each of the switches in order to set the inverter configuration to one of a first plurality of inverter configurations of a first switching mode, each one of the first plurality of inverter configurations corresponding to one of a first plurality of voltage levels, and
in response to failure of one or more of the plurality of switches and/or one or more of the plurality of DC capacitors, selecting a first alternative switching mode and setting the switching state for each of the switches in order to set the inverter configuration to one of a second plurality of inverter configurations of the first alternative switching mode, each one of the second plurality of inverter configurations corresponding to one of a second plurality of voltage levels.

2. The PV multilevel inverter of claim 1, wherein a number of the second plurality of inverter configurations is a same as or less than a number of the first plurality of inverter configurations.

3. The PV multilevel inverter of claim 2, wherein the number of the first plurality of inverter configurations is one of thirteen, nine, or seven and wherein the number of the second plurality of inverter configurations is one of thirteen, nine, or seven.

4. The PV multilevel inverter of claim 1, wherein each one of the first plurality of inverter configurations and each one of the second plurality of inverter configurations is one of a packed e-cell (PEC) or a packed u-cell (PUC) configuration.

5. The PV multilevel inverter of claim 1, wherein the controller is further configured to regulate the power output by, in response to a failure of another one or more of the plurality of switches or the plurality of DC capacitors, setting the switching state for each of the switches in order to set the inverter configuration to one of a third plurality of inverter configurations of a second alternative switching mode, each one of the third plurality of inverter configurations corresponding to one of a third plurality of voltage levels.

6. The PV multilevel inverter of claim 1, wherein the first alternative switching mode is one of six alternative switching modes.

7. The PV multilevel inverter of claim 1, wherein the plurality of power switches includes six power switches.

8. The PV multilevel inverter of claim 1, wherein the plurality of bidirectional switches includes three four-quadrant switches.

9. The PV multilevel inverter of claim 1, wherein the plurality of DC capacitors includes four DC capacitors.

10. A PV system including fault tolerance capability, the PV system comprising:
a PV array;
a boost converter configured to draw power from the PV array;
a fault detection system configured to determine a fault status of the PV system;
a PV multilevel inverter configured to convert DC voltage from the boost converter into an AC voltage, the PV multilevel inverter comprising:
a plurality of switches including a plurality of power switches and a plurality of bidirectional switches;
a plurality of DC capacitors, each one of the plurality of DC capacitors connected between at least one of the plurality of power switches and at least one of the plurality of bidirectional switches; and
a controller configured to regulate a power output of the PV multilevel inverter according to grid input frequency and grid input voltage by varying an inverter configuration by:
based on the fault status of the PV system, selecting a first alternative switching mode of six alternative switching modes, and
setting a switching state for each of the switches in order to set the inverter configuration to one of a first plurality of inverter configurations of the first alternative switching mode, each one of the first plurality of inverter configurations corresponding to one of a first plurality of voltage levels.

11. The PV system of claim 10, wherein the fault status corresponds to a failure in one or more of the plurality of switches and/or one or more of the plurality of DC capacitors.

12. The PV system of claim 11, wherein the fault detection system determines the fault status using current and/or voltage sensors.

13. The PV system of claim 10, wherein the boost converter is configured to optimize the power draw from the PV array using maximum power point tracking (MPPT).

14. The PV system of claim 10, wherein the PV system is configured to supply the power output of the PV multilevel inverter to a power grid.

15. A method of using a PV multilevel inverter including fault tolerance capability, the method comprising:
boosting a voltage of power received by a PV array to generate a stepped up DC voltage;
supplying the stepped up DC voltage to a PV inverter;
detecting a fault status of the PV inverter, the fault status corresponding to a failure in one or more of a plurality of switches of the PV inverter and/or one or more of a plurality of DC capacitors of the PV inverter;
converting the DC voltage to an AC voltage by the PV inverter by:
selecting a switching mode to one of six alternative switching modes based on the fault status; and
varying an inverter configuration between ones of a plurality of inverter configurations of the switching mode, each one of the plurality of inverter configurations corresponding to a voltage level; and
supplying the AC voltage to a power grid.

16. The method of claim 15, further including:
detecting an updated fault status of the PV inverter based on failure of another one or more of the plurality of switches of the PV inverter and/or the plurality of DC capacitors of the PV inverter; and
selecting a second switching mode from the six alternative switching modes based on the updated fault status.

17. The method of claim 15, wherein each one of the six alternative switching modes includes thirteen, nine, or seven inverter configurations.

18. The method of claim 15, wherein the detecting of the fault status includes sensing one or more of current and voltage of the PV inverter.

19. The method of claim 15, further including regulating the AC voltage to correspond to a grid frequency and a grid voltage by the varying of the inverter configuration.

20. The method of claim 15, wherein the boosting of the voltage includes using MPPT to optimize a power draw from the PV array.
